(19) United States
(12) Patent Application Publication
(10) Pub. No.: US 2026/0163255 A1
(43) Pub. Date: Jun. 11, 2026

(54) CLAMPING BODY, CONNECTION ASSEMBLY, AND CONNECTION TERMINAL

(71) Applicant: Phoenix Contact GmbH & Co. KG, Blomberg (DE)

(72) Inventor: Andreas SCHRADER, Delbrueck (DE)

(21) Appl. No.: 18/724,636

(22) PCT Filed: Dec. 16, 2022
(86) PCT No.: PCT/EP2022/086389

§ 371 Date: Jun. 27, 2024

(30) Foreign Application Priority Data
Jan. 4, 2022 (BE) BE2022/4999

(51) Int. Cl. H01R 4/36

(52) U.S. Cl. CPC H01R 4/363

(57) ABSTRACT

A clamping body for receiving a conductor to be connected includes: a base wall; a first side wall; a second side wall opposite the first side wall; and a clamping-screw receiving portion opposite the base wall and which has a threaded screw opening for receiving a clamping screw, the clamping-screw receiving portion including a first tab portion, a second tab portion resting on the first tab portion, and a third tab portion resting on the second tab portion, the threaded screw opening extending through the first tab portion, the second tab portion, and the third tab portion.

### CROSS-REFERENCE TO PRIOR APPLICATIONS

This application is a U.S. National Phase application under 35 U.S.C. § 371 of International Application No. PCT/EP2022/086389, filed on Dec. 16, 2022, and claims benefit to Belgian Patent Application No. BE2022/4999, filed on Jan. 4, 2022. The International Application was published in German on Jul. 13, 2023 as WO/2023/131500 A1 under PCT Article 21(2).

### FIELD

The invention relates to a clamping body for receiving a conductor to be connected. The invention further relates to a connection assembly having such a clamping body and a connection terminal having such a connection assembly.

### BACKGROUND

Various embodiments of clamping bodies are known. There are two fundamental differences in the manufacture between clamping bodies. In the first manufacturing method, the clamping body is punched out from a flat strip of material and bent; in the second manufacturing method, the clamping body is made from a drawn wire material by broaching. Manufacture by punching and bending has the advantage over manufacture by broaching that conventional punching/bending machines can be used. Broaching machines are special-purpose machines that must be purchased first. In addition, manufacturing a clamping body by broaching is technically more complex and more time-consuming, which increases costs as compared to a bent clamping body.

Some of the commercially known clamping bodies that are manufactured using punching and bending processes are configured such that two tabs rest on each other in the region of the passage for the clamping screw. A threaded through-hole is formed through both tabs to receive the clamping screw. The advantage here is that the two tabs can move relative to each other, causing jamming of the clamping screw, which is referred to as “screw brake.” This prevents the screwed-in clamping screw from turning out of, or further into, the clamping body by itself, e.g., under vibration. Clamping bodies having two tabs resting on each other are known, for example, from DE 1 996 971 U and DE 3 149 948 A1. The number of load-bearing thread turns is relatively low due to the two stacked tabs because the material thickness of the flat strip of material is selected to be as thin as possible for reasons of space and cost. The risk of the thread turns in the tabs being destroyed by the screw or clamping force applied is therefore very high. For these reasons, other commercially available clamping bodies have an extruded threaded hole in one of the tabs. This increases the number of load-bearing threads on the one hand, but on the other, the effect of jamming of the clamping screw may no longer be present when only one tab is formed with a thread, as is provided for in DE 10 2011 051 231 A1 and DE 20 2006 018 023 U1, for example. This results in the need for an additional contour, for example, in the insulating enclosure of the connection terminal to prevent the clamping screw from turning out of, or into, the clamping body by itself. In addition, producing an extruded threaded hole requires additional manufacturing effort, which cannot be produced by every manufacturer. This reduces the number of suppliers and thus increases costs.

### SUMMARY

In an embodiment, the present invention provides a clamping body for receiving a conductor to be connected, the clamping body comprising: a base wall; a first side wall; a second side wall opposite the first side wall; and a clamping-screw receiving portion opposite the base wall and which has a threaded screw opening configured to receive a clamping screw, the clamping-screw receiving portion comprising a first tab portion, a second tab portion resting on the first tab portion, and a third tab portion resting on the second tab portion, the threaded screw opening extending through the first tab portion, the second tab portion, and the third tab portion.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic perspective view of a clamping body according to a first embodiment of the invention;

FIG. 2 is a schematic side view of the clamping body shown in FIG. 1;

FIG. 3 is a schematic view showing the clamping body of FIG. 1 as it is bent into the final shape;

FIG. 4 is a schematic view showing a punched flat strip material according to the first embodiment of the invention prior to bending into the final shape of the clamping body;

FIG. 5 is a schematic view showing a connection assembly according to the first embodiment of the invention with a connected conductor;

FIG. 6 is a schematic perspective view of a clamping body according to a second embodiment of the invention;

FIG. 7 is a schematic side view of the clamping body shown in FIG. 1;

FIG. 8 is a schematic view showing the clamping body of FIG. 1 as it is bent into the final shape;

FIG. 9 is a schematic view showing a punched flat strip material according to the second embodiment of the invention prior to bending into the final shape of the clamping body; and

FIG. 10 is a schematic view showing a connection assembly according to the second embodiment of the invention with a connected conductor.

### DETAILED DESCRIPTION

In an embodiment, the present invention provides a clamping body, a connection assembly, and a connection terminal that feature increased safety and stability when connecting a conductor and, at the same time, reduce manufacturing effort.

The clamping body according to the invention has a base wall, a first side wall, a second side wall opposite the first side wall, and a clamping-screw receiving portion which is opposite the base wall and which has a threaded screw opening for receiving a clamping screw, the clamping-screw receiving portion being formed by a first tab portion, a second tab portion resting on the first tab portion, and a third tab portion resting on the second tab portion; the threaded screw opening extending through the first tab portion, the second tab portion, and the third tab portion.

The clamping body according to the invention is characterized in that the clamping-screw receiving portion is formed by three tab portions resting on each other; the threaded screw opening, into which a clamping screw is screwed, extending through all three of these tab portions. Due to the three tab portions resting on each other, the clamping-screw receiving portion may have a greater total wall thickness, whereby particularly secure retention of a clamping screw is possible. This makes it possible to achieve a convenient height for receiving the clamping screw, which in turn enables achieving a very good load-bearing capacity of the threaded screw opening for receiving the clamping screw. By providing three tab portions resting on each other, increased inherent stability of the clamping body is achieved, so that no additional contours are needed, for example, on an insulating enclosure surrounding the clamping body, in order to prevent the clamping screw from loosening itself from the threaded screw opening of the clamping-screw receiving portion.

This reduces the manufacturing effort significantly. The second tab portion rests preferably flat on the first tab portion, and the third tab portion rests preferably flat on the second tab portion. The second tab portion is disposed between the first tab portion and the third tab portion.

It is preferred that the first tab portion and the third tab portion are integrally formed in one piece, an opening being formed at a transition region between the first tab portion and the third tab portion, through which opening the second tab portion is passed.

Because of such arrangement, the three tab portions are interleaved with each other. This makes it possible to prevent unwanted movement of the tab portions relative to each other.

The opening in the transition region between the first tab portion and the third tab portion may be slot-shaped. At the transition region, the first tab portion and the third tab portion are preferably integrally joined in one piece. The transition region is preferably formed as a bend. The first tab portion and the third tab portion, together with the transition region, preferably form a U-shape. The second tab portion may be bent and inserted into this U-shape so that the second tab portion may be embraced by the U-shape. The three tab portions are preferably arranged in a sandwich configuration.

The second tab portion may be connected to the first side wall. For this purpose, the second tab portion may be integrally joined to an end portion of the first side wall. The first tab portion and the third tab portion, on the other hand, may be connected to the second side wall. For this purpose, the first tab portion is preferably integrally joined directly to an end portion of the second side wall. The third tab portion is preferably indirectly connected to the second side wall via the first tab portion. For this purpose, the third tab portion may be integrally joined to the first tab portion. The first tab portion is then disposed between the second side wall and the third tab portion.

The second tab portion is preferably bent at a 90° angle with respect to the first side wall. Thus, the second tab portion preferably extends at a right angle to the first side wall. The second tab portion is then bent, starting at the first side wall, in a direction toward the second side wall.

The first tab portion is preferably bent at a 90° angle with respect to the second side wall. Thus, the first tab portion preferably extends at a right angle to the second side wall. The first tab portion is then bent, starting at the second side wall, in a direction toward the first side wall.

The third tab portion is preferably bent at a 180° angle with respect to the first tab portion. Thus, starting from the junction or transition region between the first tab portion and the third tab portion, the third tab portion preferably extends in a direction back toward the second side wall. Thus, the third tab portion, too, preferably extends at a right angle to the second side wall.

The first tab portion and the third tab portion preferably have the same width. In contrast, the width of the second tab portion preferably differs from the width of the first tab portion and from the width of the third tab portion. The second tab portion preferably has a width that is smaller than the width of the first tab portion and smaller than the width of the third tab portion.

In order to ensure a defined and stable position of the three tab portions relative to each other, in particular also under vibrations, the second tab portion may rest without play on the first tab portion, and the third tab portion may rest without play on the second tab portion. The three tab portions may then rest on each other in the manner of a press fit.

In order to achieve the simplest possible way of producing the clamping body, the clamping body may be formed from a punched and bent flat strip material. The flat strip material may, for example, be a steel material or a copper material.

The threaded screw opening may be formed by punching a first opening into the first tab portion, a second opening into the second tab portion, and a third opening into the third tab portion, and subsequently positioning the three tab portions on each other by bending such that the first opening is in alignment with the second opening and the third opening, and by subsequently cutting a threaded hole into the first opening, the second opening, and the third opening disposed one above the other in aligned relationship. The formation of the threaded screw opening may thus be carried out in two steps. First, the three openings in the respective tab portions may be punched into the flat strip material simultaneously while the clamping body is punched out from the flat strip material. After the clamping body has been bent into its final shape and the three openings have been positioned in alignment one above the other, the actual thread for receiving the clamping screw may be cut into these three openings in a second step. The threaded hole may thus be formed into and configured in all three openings of the three tab portions. In this case, there is no need to provide an extruded threaded hole. When the threaded screw opening is formed in this way, it can reliably provide a screw brake and thus for jamming of the clamping screw in order to prevent unwanted loosening of the clamping screw from the threaded screw opening.

In an embodiment, the invention provides a connection assembly including a clamping body, a clamping screw received in the threaded screw opening of the clamping body, and a current bar inserted in the clamping body, the clamping body being embodied and refined as described above. A conductor to be connected may be inserted into the clamping body and clamped against the current bar by the clamping screw within the clamping body, and may thus be connected.

In an embodiment, the invention provides a connection terminal including a housing and at least one connection assembly disposed in the housing, the connection assembly being embodied and refined as described above. The connection terminal may be, for example, a PCB connection terminal or a terminal block.

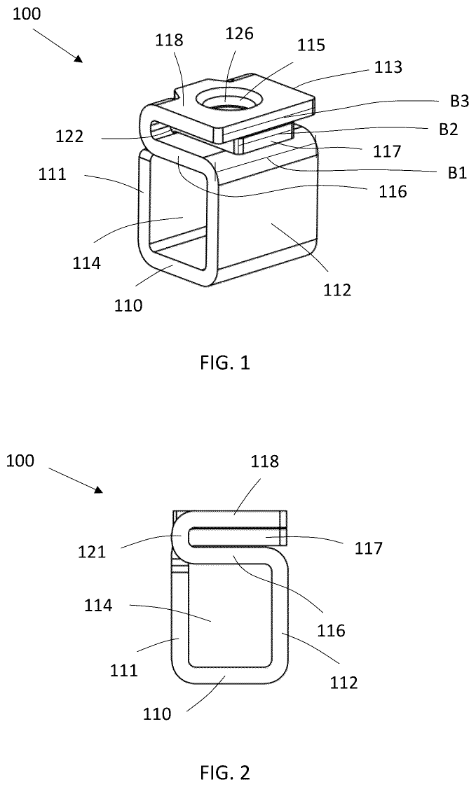

FIGS. 1 and 2 show schematic illustrations of a clamping body 100. Clamping body 100 is entirely formed in one piece from a flat strip material F.

Clamping body 100 has a base wall 110, a first side wall 111, a second side wall 112, and a clamping-screw receiving portion 113. First side wall 111 is disposed opposite second side wall 112. First side wall 111 and the second side wall extend parallel to each other. Clamping-screw receiving portion 113 is disposed opposite base wall 110. An interior space 114 of clamping body 100, in which a conductor 300 to be connected can be clamped, is bounded by the two side walls 111, 112, the base wall, and clamping-screw receiving portion 113.

Clamping-screw receiving portion 113 has a threaded screw opening 115 for receiving a clamping screw 210, as shown in FIG. 5.

Clamping-screw receiving portion 113 is formed by a first tab portion 116, a second tab portion 117, and a third tab portion 118. As can be seen in particular also in FIG. 2, the three tab portions 116, 117, 118 are disposed one above the other. Second tab portion 117 rests on first tab portion 116, and third tab portion 118 rests on second tab portion 117.

Threaded screw opening 115 extends through all three tab portions 116, 117, 118.

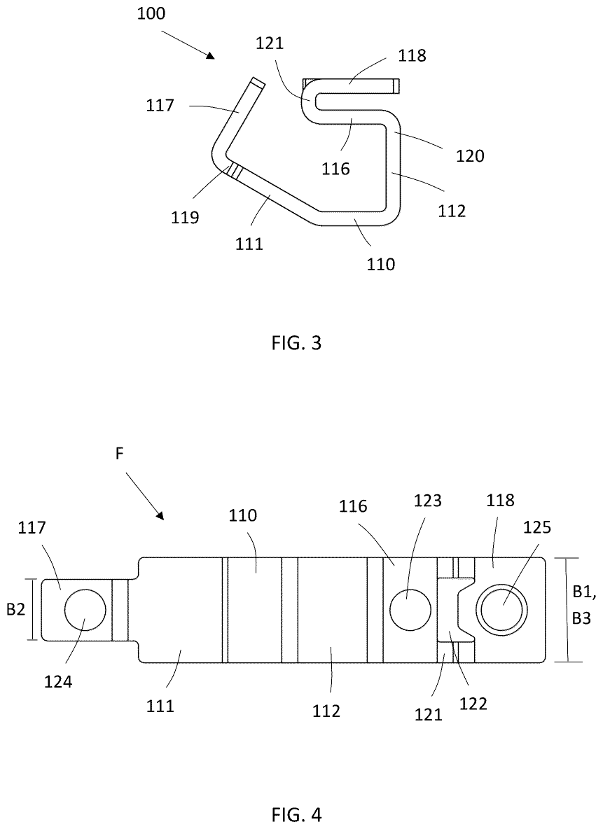

As can be seen in particular also in FIG. 3, second tab portion 117 is joined to first side wall 111. Second tab portion 117 adjoins an end portion 119 of first side wall 111 integrally therewith. Second tab portion 117 is bent at a 90° angle with respect to first side wall 111.

First tab portion 116 and third tab portion 118, on the other hand, are joined to second side wall 112. First tab portion 116 directly adjoins second side wall 112. First tab portion 116 is integrally joined to an end portion 120 of second side wall 112. Third tab portion 118 is joined to second side wall 112 via first tab portion 116. First tab portion 116 is bent at a 90° angle with respect to second side wall 112. Third tab portion 118 is bent at a 180° angle with respect to first tab portion 116. Together with a transition region 121 between first tab portion 116 and third tab portion 118, these tab portions form a U-shape.

Formed in transition region 121 between first tab portion 116 and the third tab portion 118 is an opening 122 through which second tab portion 117 is passed, as can be seen in particular in FIG. 1. Second tab portion 117 can thus extend into the U-shaped clearance formed between first tab portion 116 and third tab portion 118. This allows tab portions 116, 117, 118 to be arranged in an interleaved fashion. Opening 122 in transition region 121 between first tab portion 116 and third tab portion 118 is slot-shaped.

As can be further seen in FIG. 1, first tab portion 116 has a width B1, which corresponds to width B3 of third tab portion 118. Second tab portion 117, on the other hand, has a width B2 that is smaller than width B1 of first tab portion 116 and smaller than width B3 of third tab portion 118.

In the embodiment shown here, the three tab portions 116, 117, 118 rest flat on one another in such a way that second tab portion 117 rests without play on first tab portion 116 and that third tab portion 118 rests without play on second tab portion 117. This makes it possible to prevent relative movement between the stacked tab portions 116, 117, 118.

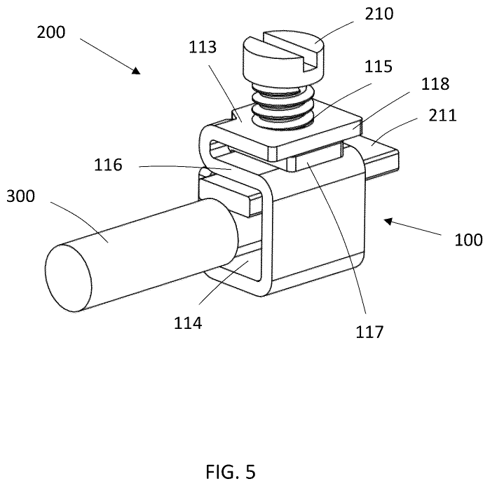

FIG. 4 shows the flat strip material F for forming a clamping body 100. Here, flat strip material F has already been punched into the desired shape. It can be seen that the two side walls 111, 112, base wall 110, and first tab portion 116, and third tab portion 118 have the same width B1, B3. Second tab portion 117, on the other hand, has a smaller width B2.

Furthermore, slot-shaped opening 122 has already been punched into transition region 121 between first tab portion 116 and third tab portion 118. Moreover, openings 123, 124, 125 are punched into flat strip material F in the region of the three tab portions 116, 117, 118, respectively, which openings are disposed one above the other in aligned relationship after flat strip material F is bent into the shape of clamping body 100. Subsequent to the bending of flat strip material F, when these three openings 123, 124, 125 are disposed one above the other, a threaded hole 126 is cut into all three openings 123, 124, 125 in one step to form threaded screw opening 115, via which clamping screw 210 is later screwed in and retained.

FIG. 5 shows a connection assembly 200 having such a clamping body 100. A clamping screw 210 is screwed into threaded screw opening 115 in the region of clamping-screw receiving portion 113 of clamping body 100. A current bar 211 is inserted in interior space 114 of clamping body 100. Also shown is a conductor 300, which is inserted in interior space 114 of clamping body 100; current bar 211 and the conductor 300 to be connected being clamped against each other by clamping screw 210 in order to connect conductor 300.

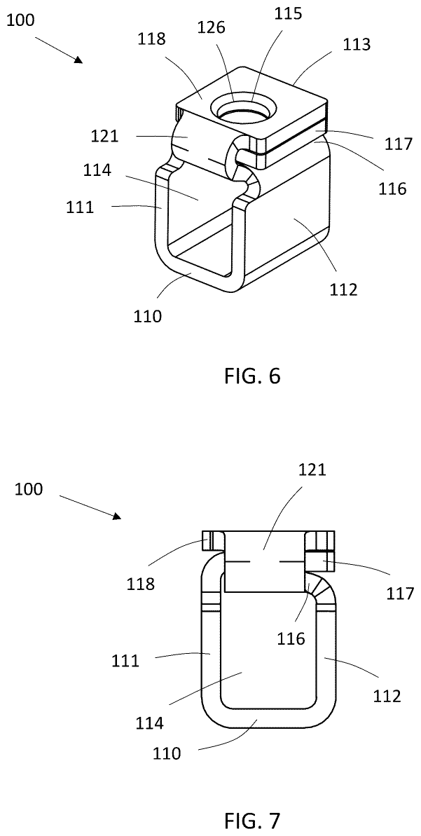

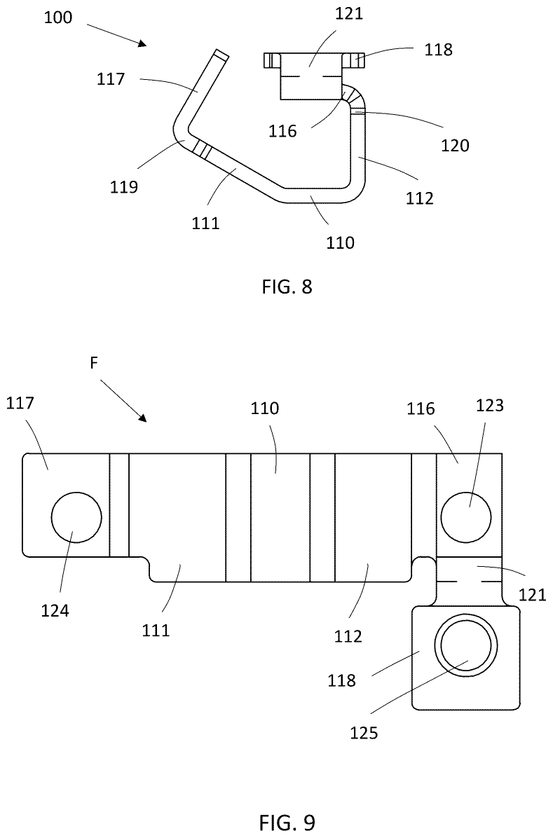

FIGS. 6 through 10 show another embodiment of a clamping body 100. This embodiment is substantially similar to the embodiment shown in FIGS. 1 through 5.

The difference is that the three tab portions 116, 117, 118 are not arranged one behind the other in a line in flat strip material F, as provided for in the embodiment shown in FIGS. 1 through 5. In contrast, in the embodiment shown in FIGS. 6 through 10, third tab portion 118 extends at a 90° angle to first tab portion 116 and second tab portion 117, as can be seen in particular in FIG. 9. This angled disposition of third tab portion 118 eliminates the need to provide an opening 122 in transition region 121 between first tab portion 116 and third tab portion 118 to allow second tab portion 117 to protrude therethrough. Nevertheless, in the embodiment shown in FIGS. 6 through 10, it is possible that clamping-screw receiving portion 113 is formed by first tab portion 116, a second tab portion 117 resting on first tab portion 117, and third tab portion 118 resting on second tab portion 117, the threaded screw opening 115 extending through first tab portion 116, second tab portion 117, and third tab portion 118, as can be seen in particular in FIGS. 6 through 8.

Thus, in the embodiment shown in FIGS. 6 to 10, second tab portion 117 also extends into the U-shaped clearance formed between first tab portion 116 and third tab portion 118. This allows the three tab portions 116, 117, 118 to be arranged in an interleaved fashion.

In the embodiment shown here, the three tab portions 116, 117, 118 also rest flat on one another in such a way that second tab portion 117 rests without play on first tab portion 116 and that third tab portion 118 rests without play on second tab portion 117. This makes it possible to prevent relative movement between the stacked tab portions 116, 117, 118.

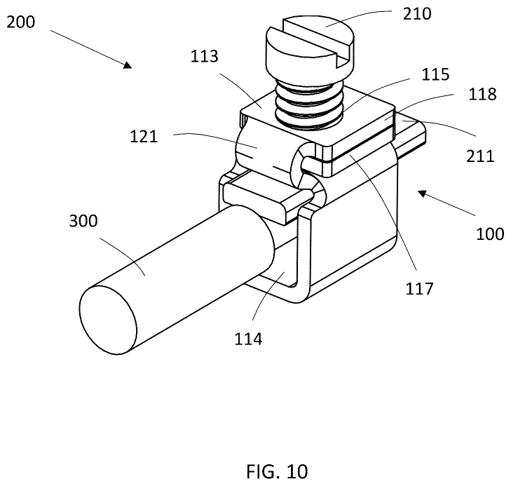

FIG. 10 shows a connection assembly 200 having a clamping body 100 as shown in FIGS. 6 through 8. A clamping screw 210 is screwed into threaded screw opening 115 in the region of clamping-screw receiving portion 113 of clamping body 100. A current bar 211 is inserted in interior space 114 of clamping body 100. Also shown is a conductor 300, which is inserted in interior space 114 of clamping body 100; clamping current bar 211 and the conductor 300 to be connected being clamped against each other by clamping screw 210 in order to connect conductor 300.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

100 clamping body
110 base wall
111 first side wall
112 second side wall
113 clamping-screw receiving portion
114 interior space
115 threaded screw opening
116 first tab portion
117 second tab portion
118 third tab portion
119 end portion
120 end portion
121 transition region
122 opening
123 opening
124 opening
125 opening
126 threaded hole
200 connection assembly
210 clamping screw
211 current bar
300 conductor
F flat strip material
B1 width of the first tab portion
B2 width of the second tab portion
B3 width of the third tab portion

1. A clamping body for receiving a conductor to be connected, the clamping body comprising:
a base wall;
a first side wall;
a second side wall opposite the first side wall; and
a clamping-screw receiving portion opposite the base wall and which has a threaded screw opening configured to receive a clamping screw,
the clamping-screw receiving portion comprising a first tab portion, a second tab portion resting on the first tab portion, and a third tab portion resting on the second tab portion; the threaded screw opening extending through the first tab portion the second tab portion and the third tab portion.

2. The clamping body of claim 1,
wherein the first tab portion and the third tab portion are integrally formed in one piece, an opening being formed at a transition region between the first tab portion and the third tab portion, through which opening the second tab portion is passed.

3. The clamping body of claim 1,
wherein the second tab portion is connected to the first side wall and
wherein the first tab portion and the third tab portion are connected to the second side wall.

4. The clamping body of claim 1,
wherein the second tab portion extends at a 90° angle to the first side wall.

5. The clamping body of claim 1,
wherein the first tab portion extends at a 90° angle to the second side wall.

6. The clamping body of claim 1,
wherein the third tab portion extends at a 180° angle to the first tab portion

7. The clamping body of claim 1,
wherein the second tab portion has a width that is smaller than a width of the first tab portion and smaller than a width of the third tab portion.

8. The clamping body of claim 1,
wherein the second tab portion rests without play on the first tab portion, and
wherein the third tab portion rests without play on the second tab portion.

9. The clamping body of claim 1,
wherein the clamping body comprises a punched and bent flat strip material.

10. The clamping body of claim 1,
wherein the threaded screw opening is formed by punching a first opening into the first tab portion a second opening into the second tab portion and a third opening into the third tab portion and subsequently positioning the first, second, and third tab portions on each other by bending, such that the first opening is in alignment with the second opening and the third opening, and by subsequently cutting a threaded hole into the first opening the second opening, and the third opening disposed one above another in aligned relationship.

11. A connection assembly, comprising:
the clamping body of claim 1;
a clamping screw received in the threaded screw opening; and
a current bar inserted in the clamping body.

12. A connection terminal, comprising:
a housing; and
at least one connection assembly of claim 11 disposed in the housing.
